(19) United States
(12) Patent Application Publication
(10) Pub. No.: US 2002/0099203 A1
(43) Pub. Date: Jul. 25, 2002

(54) Processes for the production of alkali cellulose and cellulose ether

(76) Inventor: Kazuto Kobayashi, Niigata-ken (JP)

Correspondence Address: MYERS BIGEL SIBLEY & SAJOVEC, PO BOX 37428, RALEIGH, NC, 27627, US

(21) Appl. No.: 09/784,468

(22) Filed: Feb. 15, 2001

(30) Foreign Application Priority Data
Feb. 15, 2000 (JP) 2000-036062

(51) Int. Cl. C08B 15/05; C08B 15/02

(52) U.S. Cl. 536/84; 536/101

(57) ABSTRACT

The present invention provides a process for the production of an alkali cellulose which exhibits a very uniform distribution of alkali in the alkali cellulose and has a high bulk density. Moreover, the high bulk density of the alkali cellulose makes it possible to charge a smaller reaction vessel with a greater amount of the alkali cellulose in an etherification reaction step and thereby produce a cellulose ether having very excellent solubility. Specifically, powdered pulp obtained by grinding pulp to a powder is continuously fed to a double-shaft kneader and mixed with an aqueous alkaline solution which is simultaneously and continuously fed thereto through the same inlet port or at another site. After they are mixed and densified within the kneader, the resulting product is continuously discharged from an outlet port. The feed rate of the powdered pulp is controlled by a metering feeder so as to feed it at a desired flow rate. The feed rate of the aqueous alkaline solution is controlled by a metering pump so as to feed it continuously at a rate which gives a predetermined alkali concentration.

### BACKGROUND OF THE INVENTION

1. Field of the Invention

This invention relates to processes for the production of alkali cellulose and cellulose ether.

2. Description of the Related Art

It is known that cellulose ethers are produced by bringing highly purified pulp into contact with an aqueous alkaline solution to prepare an alkali cellulose and etherifying this alkali cellulose with the aid of an etherifying agent.

The finally obtained cellulose ether can be made water-soluble by controlling the degree of substitution properly. However, it may contain a water-insoluble fraction which will reduce the light transmittance of its aqueous solutions or will constitute a contaminant and thereby detract from its commercial value.

This insoluble fraction arises from the presence of a low-substituted portion which does not have a sufficient amount of substituent groups to provide solubility in water. Thus, one cause therefor is believed to be that the distribution of alkali in the alkali cellulose is not uniform. The functions of the alkali cellulose are to assist in the infiltration of an etherifying agent by swelling cellulose to change its crystalline structure in the pulp, to catalyze the etherification reaction of an alkylene oxide, to serve as a reactant with an alkylene halide, and the like.

Consequently, a portion of pulp which does not come into contact with an aqueous alkaline solution undergoes no reaction and hence constitutes an insoluble fraction. Thus, the homogeneity of an alkali cellulose is directly related to the amount of an insoluble fraction.

According to one process for the production of an alkali cellulose, pulp is dipped in an aqueous solution of sodium hydroxide so as to allow the pulp to absorb a sufficient amount of alkali, and then pressed to remove any excess alkali and thereby give a predetermined alkali concentration. However, this process is disadvantageous from the viewpoint of productivity because troublesome operations are required and it is difficult to achieve control so as to give a predetermined alkali concentration.

On the other hand, a process in which a predetermined amount of an alkali is added to powdered pulp and mechanically mixed therewith is highly productive, because this process can be easily controlled so as to give a predetermined alkali concentration and involves only one step.

One example of this mechanical mixing process is a batch process in which powdered pulp and an aqueous solution of sodium hydroxide are charged into a double-shaft kneader. In such a kneader type mixer, the relative contact area between the agitator blades and the mixture becomes smaller as the mixing volume is increased. This reduces the mixing effect, requires a relatively longer time for making the mixture homogeneous, and causes a marked increase in the scale of the equipment.

In a mixer having Proshear type agitator blades and a chopper, an increase in equipment size makes it difficult for the chopper to exert a shearing action, similarly to the aforesaid kneader. This not only creates microscopic inhomogeneity, but also requires large-sized equipment and hence imposes a heavy burden from the viewpoint of floorspace and cost. Such Proshear type mixers include ones of the batch type and the continuous type. In both types, however, the mixture cannot be entirely prevented from flowing backward from the alkali cellulose outlet side to the pulp inlet side, so that the discharged product may contain an inhomogeneous portion.

Thus, it is difficult to mix a relatively small amount of alkali uniformly, in its true sense, with cottony powdered pulp by mechanical means. If a cellulose ether is prepared from such an alkali cellulose, the insoluble fraction thereof will be more than that resulting from the use of an alkali cellulose produced by the aforesaid dipping process.

Accordingly, an attempt has been made to improve the uniformity of alkali by using a dilute aqueous alkaline solution and thereby increasing the volume of the aqueous solution. However, this is undesirable in that the water present in the system causes an undesirable side reaction with an etherifying agent in a subsequent etherification reaction step, resulting in a marked reduction in the efficiency of the primary reaction of cellulose with the etherifying agent. Although it is not impossible to remove the water prior to the etherification reaction, this is impracticable because the vapor pressure of the aqueous alkaline solution is very low as compared with water.

A process which uses a lower primary alcohol miscible with an aqueous alkaline solution to increase the volume of the aqueous alkaline solution/alcohol mixture has also been proposed in Japanese Patent No. 1325759. However, such a lower primary alcohol tends to cause a side reaction with an etherifying agent and, therefore, it is a prerequisite to remove the alcohol prior to the etherification reaction.

Moreover, investigations have been made on a method for improving the homogeneity of an alkali cellulose by using a large amount of an inert dispersant (e.g., dimethoxyethane or dimethyl ether) in such a mixer or a vertical mixing tank equipped with simple agitator blades, (Japanese Patent Provisional Publication Nos. 56-16501/'81 and 58-103501/'83). However, after the preparation of the alkali cellulose, the dispersant needs to be removed before the etherification reaction or during purification after the etherification reaction. This requires troublesome steps and unavoidably causes an increase in cost.

The alkali celluloses produced by these conventional techniques not only show a nonuniform distribution of alkali, but also suffer a serious physical defect in that they tend to be very fluffy and are in the form of cotton having a low bulk density. The reason for this is that, since pulp fibers can move relatively freely during the mixing of powdered pulp with an aqueous alkaline solution, the resulting alkali cellulose retains the shape of pulp fibers used as the raw material.

Moreover, if the alkali cellulose has a low bulk density per unit weight, the amount of alkali cellulose which can be charged into a reaction vessel for an etherification reaction carried out subsequently to the preparation of the alkali cellulose is limited. This makes it impossible to achieve high productivity.

### SUMMARY OF THE INVENTION

The present invention provides a process for the production of an alkali cellulose which exhibits a very uniform distribution of alkali in the alkali cellulose and has a high bulk density. Moreover, the high bulk density of the alkali cellulose makes it possible to charge a smaller reaction vessel with a greater amount of the alkali cellulose in an etherification reaction step and thereby produce a cellulose ether having very excellent solubility.

According to the present invention, powdered pulp obtained by grinding pulp to a powder is fed to a double-shaft kneader and mixed with an aqueous alkaline solution which is simultaneously fed thereto through the same inlet port or at another site. After they are mixed and densified within the kneader, the resulting product is continuously discharged from an outlet port.

The feed rate of the powdered pulp is controlled by a metering feeder so as to feed it at a desired flow rate. The feed rate of the aqueous alkaline solution is controlled by a metering pump so as to feed it at a rate which gives a predetermined alkali concentration. Although the aqueous alkaline solution may be fed through the same inlet port as the powdered pulp, it is desirable to feed the aqueous alkaline solution through another inlet port located immediately after the inlet port for the powdered pulp so that the powdered pulp may not form a lump and thereby block up the inlet port.

Powdered pulp and an aqueous alkaline solution may be mixed in advance and this mixture may be fed to a double-shaft kneader continuously. This pre-mixture does not have to be a uniform mixture thereof because it will pass through the double-shaft kneader so that a uniform alkali cellulose can be obtained. The pre-mixture may be obtained, for example, by a continuous Proshear type mixer, wherein powdered pulp and an aqueous solution are continuously fed and the resulting mixture is continuously discharged.

The alkali cellulose produced by the process of the present invention is characterized in that the alkali is very uniformly distributed in the alkali cellulose. Consequently, when this alkali cellulose is used to produce cellulose ethers such as methylcellulose (MC), the resulting cellulose ethers have very excellent solubility.

Moreover, since the alkali cellulose produced by the process of the present invention has a high bulk density, it is possible to charge a smaller reaction vessel with a greater amount of the alkali cellulose in a subsequent etherification reaction step and thereby achieve higher productivity.

### DETAILED DESCRIPTION OF THE PREFERRED EMBODIMENTS

The double-shaft kneader used in the present invention preferably may comprise two shafts each comprising a screw and a paddle, and a trough (or barrel or housing) having the shape of two overlapping hollow cylinders with a radius slightly larger than the radius of rotation of the shaft. As the paddles, it is preferable to use a combination of a flat paddle for kneading purposes and a helical paddle for kneading and conveying purposes. The screws are used for conveying purposes.

Pulp which is continuously fed through an inlet port is conveyed by the screw and brought into contact with a continuously fed aqueous alkaline solution. The mixture is blended and densified while they undergo a shearing action between the paddle and the trough and between paddles, so that the alkali is uniformly dispersed and infiltrated into the pulp. Finally, the resulting product is discharged from an outlet port located at the end of the shafts. Since each portion of the mixture being kneaded moves through a narrow space while being constantly pushed by another portion of the mixture, the final product is not contaminated with the still inhomogeneous mixture being kneaded. When the feed rate is constant, the residence time in the kneader is determined by the rotational speed of the shafts and the L/D ratio (i.e., the ratio of the length (L) of the trough to the diameter (D) of the paddle). The degree of kneading is determined by the L/D ratio and the combination of built-in paddles. The L/D ratio may be usually in the range of about 5 to 13. Unduly high L/D ratios may be undesirable because excessive kneading causes a reduction in the degree of polymerization. The main body of the kneader may have a jacket through which water is made to flow, so that the generation of heat by the mixing of an alkali with cellulose can be controlled to regulate the internal temperature. When oxygen is present, the atmosphere may be replaced with a vacuum or nitrogen in order to prevent a reduction in the degree of polymerization of the alkali cellulose. Where it is desired to control the degree of polymerization in the presence of oxygen, the kneader may have a construction which permits the oxygen concentration to be regulated.

One commercially available example of the above-described double-shaft kneader is KRC Kneader (manufactured by Kurimoto Tekkojo Co., Ltd.). It is a matter of course that the kneader which can be used in the present invention are not limited to a so-called kneader, but also includes a mixer, a kneading extruder and the like, so long as it permits the objects, action and effects of the present invention to be substantially achieved.

The aqueous alkaline solution used is preferably selected from an aqueous solution of sodium hydroxide and an aqueous solution of potassium hydroxide. However, the use of sodium hydroxide is especially preferred from an economic point of view. Although its concentration is usually in the range of 30 to 60% by weight, a concentration in the vicinity of 50% by weight is more desirable in consideration of the succeeding etherification reaction and the handling of the aqueous solution.

In the present invention, the uniformity of the alkali can basically be improved without using a lower primary alcohol or other inert solvent. However, it is not precluded to employ the present invention in a system using such a solvent in combination with an aqueous alkaline solution. That is, the present invention may be applied to such a system in order to improve the uniformity of the alkali and the bulk density of the alkali cellulose.

Moreover, the process of the present invention is a continuous production process. Accordingly, it can reduce the size of the equipment as compared with batch processes and is hence advantageous from the viewpoint of floorspace requirements.

The alkali cellulose obtained by the above-described production process may be used as a raw material for the production of a cellulose ether. This reaction may be carried out either in a batch process or in a continuous process. Since the process for the production of an alkali cellulose in accordance with the present invention is a continuous one, the reaction is preferably carried out in a continuous process, but a batch process may be employed without any problem. In the case of a batch process, the alkali cellulose discharged from the double-shaft kneader may be stored in a buffer tank, or may be directly charged into an etherification reaction vessel. However, higher efficiency is achieved by storing the alkali cellulose in a buffer tank and then charging it into an etherification reaction vessel in a short period of time so as to reduce the occupied time of the reaction vessel. It is desirable that the buffer tank has an oxygen-free atmosphere by replacement with a vacuum or nitrogen in order to suppress a reduction in the degree of polymerization.

The cellulose ethers which can be obtained by using the alkali cellulose as the starting material include methylcellulose, ethylcellulose (EC), hydroxyethyl cellulose (HEC) and hydroxypropyl cellulose (HPC), as well as mixed cellulose ethers such as hydroxyethyl methylcellulose (HEMC), hydroxypropyl methylcellulose (HPMC) and carboxymethylcellulose (CMC).

Useful etherifying agent include alkyl halides such as methyl chloride and ethyl chloride; alkylene oxides such as ethylene oxide and propylene oxide; monochloroacetic acid; and the like.

The present invention is more specifically explained with reference to the following examples and comparative examples. However, these examples are not to be construed to limit the scope of the invention.

### EXAMPLE 1

Powdered pulp (with a water content of 3.0% by weight), which was obtained by grinding high-purity dissolving pulp derived from wood, was fed to a double-shaft kneader (KRC Kneader Model S1, manufactured by Kurimoto Tekkojo Co., Ltd.; with a paddle diameter of 25 mm, a trough length of 255 mm, an L/D ratio of 10.2, an internal volume of 0.12 liters, and a rotational speed of 100 rpm) at a constant rate of 10 g/min. At the same time, a 49 wt % aqueous solution of sodium hydroxide was fed at a constant rate of 12.7 g/min through an injection port provided near to the inlet port for pulp. Cold water at 20° C. was circulated through the jacket. Moreover, the atmosphere of the system was replaced with nitrogen in order to prevent a reduction in the degree of polymerization. After the kneader was continuously operated for about 30 minutes, 585.0 g of the resulting alkali cellulose was charged into a 5-liter pressure vessel equipped with a Proshear type internal agitator, which was evacuated to −97 kPa, returned to atmospheric pressure by the introduction of nitrogen, and evacuated again to −97 kPa. After the reaction vessel was charged with 52.5 g of propylene oxide and then 212.6 g of methyl chloride, reaction was effected at an internal temperature of 60° C. for 2 hours. Thereafter, the reaction vessel was heated to 90° C. and held at that temperature for 30 minutes to complete the etherification reaction. The reaction product was washed with hot water and then dried. Properties of the HPMC thus obtained are shown in Table 1. When the alkali cellulose which was not used for the reaction was poured into a 100 cc cup without exposing it to vibrations, and its bulk density was measured, it was found to be 0.33 g/ml. In all examples and comparative examples, bulk densities were measured with a powder tester (manufactured by Hosokawa Micron Corporation).

### COMPARATIVE EXAMPLE 1

300 g of the same powdered pulp as used in Example 1 was charged into a 5-liter Proshear mixer equipped with a chopper. While this mixer was operated under an atmosphere of nitrogen at a main agitation speed of 200 rpm, a chopper speed of 1,500 rpm, and a jacket temperature of 20° C., 381.3 g of a 49 wt % aqueous solution of sodium hydroxide was fed thereto over a period of 10 minutes. After the agitation was continued for an additional 10 minutes, the reaction product was discharged. Using 585.0 g of the alkali cellulose thus obtained, HPMC was prepared in the same manner as in Example 1. Properties of this HPMC are shown in Table 1. When the bulk density of the alkali cellulose was measured in the same manner as in Example 1, it was found to be 0.15 g/ml.

### EXAMPLE 2

Using powdered pulp (with a water content of 3.0% by weight) which was obtained from wood pulp having a lower degree of polymerization than that used in Example 1, an alkali cellulose was prepared in the same manner as in Example 1, except that the 49 wt % aqueous solution of sodium hydroxide was fed at a rate of 20.5 g/min. After the kneader was continuously operated for about 30 minutes, 786.8 g of the resulting alkali cellulose was charged into a 5-liter pressure vessel equipped with a Proshear type internal agitator, which was evacuated to −97 kPa, returned to atmospheric pressure by the introduction of nitrogen, and evacuated again to −97 kPa. After the reaction vessel was charged with 343.7 g of methyl chloride, reaction was effected at an internal temperature of 60° C. for 2 hours. Thereafter, the reaction vessel was heated to 90° C. and held at that temperature for 30 minutes to complete the etherification reaction. The reaction product was washed with hot water and then dried. Properties of the HPMC thus obtained are shown in Table 1. When the bulk density of the alkali cellulose was measured in the same manner as in Example 1, it was found to be 0.35 g/ml.

### COMPARATIVE EXAMPLE 2

300 g of the same powdered pulp as used in Example 2 was charged into a 5-liter Proshear mixer equipped with a chopper. While this mixer was operated under an atmosphere of nitrogen at a main agitation speed of 200 rpm, a chopper speed of 1,500 rpm, and a jacket temperature of 20° C., 615.9 g of a 49 wt % aqueous solution of sodium hydroxide was fed thereto over a period of 10 minutes. After the agitation was continued for an additional 10 minutes, the reaction product was discharged. Using 786.8 g of the alkali cellulose thus obtained, MC was prepared in the same manner as in Example 2. Properties of this MC are shown in Table 1. When the bulk density of the alkali cellulose was measured in the same manner as in Example 1, it was found to be 0.17 g/ml.

TABLE 1

| | Viscosity | | | Solution light | | Insoluble |
|---|---|---|---|---|---|---|
| | of 2 wt % | Degree of substitution | | transmittance | | matter at |
| | solution | Methoxyl | Hydroxypropoxyl | 5° C. | 30° C. | 5° C. |
| | (mPa · s) | group (wt %) | group (wt %) | (%) | (%) | (wt %) |
| Example 1 | 4550 | 23.0 | 7.0 | 95.0 | 92.0 | — |
| Example 2 | 110 | 29.5 | — | 98.5 | — | 0.02 |
| Comparative | 4850 | 23.0 | 7.0 | 70.5 | 30.0 | — |
| Example 1 | | | | | | |
| Comparative | 115 | 29.5 | — | 92.0 | — | 0.12 |
| Example 2 | | | | | | |

In Table 1, “viscosity of 2 wt % solution” was obtained by dispersing a sample in hot water for 30 minutes so as to yield a 2 wt % aqueous solution, stirring the dispersion in a bath at 5° C. for 1 hour to dissolve the sample, adjusting the temperature of the resulting solution to 20° C., and measuring its viscosity with a Brookfield rotational viscometer. “Degree of substitution by methoxyl group” and “degree of substitution by hydroxypropoxyl group” were determined by the methods described in the Pharmacopoeia of Japan. “Solution light transmittance at 5° C. was obtained by dissolving a sample at 5° C. to prepare an aqueous solution having a concentration of 2% by weight, and measuring its transmittance to white light at 20° C. while taking that of purified water as 100%. “Solution light transmittance at 30° C.” was obtained by dissolving a sample at 30° C. to prepare an aqueous solution having a concentration of 2% by weight, and measuring its transmittance to white light at 30° C. while taking that of purified water as 100%. “Insoluble matter at 5° C.” was determined by dissolving 20 g of a sample at 5° C. so as to give a concentration of 0.5% by weight, filtering the whole solution through a 400 mesh (38 μm) filter, weighing the amount of residue on the filter, and expressing it as a weight percentage based on the amount (20 g) of the sample.

1. A process for the continuous production of an alkali cellulose which comprises feeding pulp and an aqueous alkaline solution continuously to a double-shaft kneader.

2. A process for the continuous production of an alkali cellulose claimed in claim 1 wherein said feeding pulp and an aqueous alkaline solution is feeding a mixture of pulp and an aqueous alkaline solution.

3. A process for the production of a cellulose ether which comprises reacting an etherifying agent with an alkali cellulose obtained by the process of claim 1.

4. A process for the production of a cellulose ether which comprises reacting an etherifying agent with an alkali cellulose obtained by the process of claim 2.
